(19) United States
(12) Patent Application Publication
(10) Pub. No.: US 2022/0222597 A1
(43) Pub. Date: Jul. 14, 2022

(54) TIMING OF PICKUPS FOR AUTONOMOUS VEHICLES

(71) Applicant: Waymo LLC, Mountain View, CA (US)

(72) Inventor: Megan Neese, Venice, CA (US)

(21) Appl. No.: 17/146,742

(22) Filed: Jan. 12, 2021

(51) Int. Cl. G06Q 10/06

(52) U.S. Cl. CPC G06Q 10/06311

(57) ABSTRACT

Aspects of the disclosure relate to timing pickups of passengers for autonomous vehicles. For instance, while an autonomous vehicle is maneuvering itself to a pickup location for picking up a passenger, an estimated time of arrival for the passenger to reach the pickup location may be identified. The estimated time of arrival may be used to plan a route to the pickup location. The vehicle may be maneuvered to the pickup location using the route.

### BACKGROUND

Autonomous vehicles, for instance, vehicles that do not require a human driver, can be used to aid in the transport of passengers or items from one location to another. Such vehicles may operate in a fully autonomous mode where passengers may provide some initial input, such as a pickup or destination location, and the vehicle maneuvers itself to that location. Thus, such vehicles may be used to provide transportation services.

Other systems which provide transportation services typically include drivers or conductors who are tasked with making decisions about how to operate vehicles. Such services may include some backend server systems which can dispatch vehicles to certain locations to provide transportation services as well as provide fleet management and other operational functions.

### BRIEF SUMMARY

Aspects of the disclosure provide a method of timing pickups of passengers for autonomous vehicles. The method includes, while an autonomous vehicle is maneuvering itself to a pickup location for picking up a passenger, identifying, by one or more processors of the vehicle, an estimated time of arrival for the passenger to reach the pickup location; using, by the one or more processors, the estimated time of arrival to plan a route to the pickup location; and maneuvering, by the one or more processors, the vehicle to the pickup location using the route.

In one example, the method includes determining the estimated time of arrival based on a location of a client computing device and a distance between the location of the client computing device and the pickup location. In this example, the estimated time of arrival is determined further based on an expected walking speed. In addition or alternatively, determining the estimated time of arrival is in response to a triggering condition being met. In this example, the triggering condition is a predetermined amount of time before the vehicle is expected to arrive at the pickup location. Alternatively, the triggering condition is the location of the client computing device indicates that the passenger is moving towards the pickup location. In addition or alternatively, determining the estimated time of arrival is further based on whether the location of the client computing device indicates that the passenger is within a building. In this example, determining the estimated time of arrival is further based on a number of stories the building has. In addition or alternatively, determining the estimated time of arrival is further based on a classification of the building. In addition, the classification is an airport. Alternatively, the classification is a shopping center. Alternatively, the classification is an apartment building. Alternatively, the classification is a house. In addition or alternatively, determining the estimated time of arrival is further based on current weather conditions at the pickup location. In addition or alternatively, determining the estimated time of arrival is further based on current time of day at the pickup location. In addition or alternatively, determining the estimated time of arrival is further based on congestion conditions at the pickup location. In addition or alternatively, the congestion conditions include pedestrian traffic. In addition or alternatively, the congestion conditions include vehicular traffic.

In another example, the method also includes using the estimated time of arrival to determine trajectories in order to follow the route, and wherein maneuvering the vehicle to the pickup location using the route further includes using the determined trajectories. In another example, when a predetermined amount of time before the vehicle is expected to arrive at the pickup location has been reached and a received location of the client computing device indicates that the passenger is not moving towards the pickup location, sending a notification to the client computing device asking if the passenger would like to request more time to reach the pickup location.

### BRIEF DESCRIPTION OF THE DRAWINGS

FIG. 1 is a functional diagram of an example vehicle in accordance with an exemplary embodiment.

FIG. 2 is an example of map information in accordance with aspects of the disclosure.

FIG. 3 is an example external view of a vehicle in accordance with aspects of the disclosure.

FIG. 4 is a pictorial diagram of an example system in accordance with aspects of the disclosure.

FIG. 5 is a functional diagram of the system of FIG. 4 in accordance with aspects of the disclosure.

FIG. 6 is an example of a vehicle driving through a geographic area and a trajectory in accordance with aspects of the disclosure.

FIG. 7 is an example of a vehicle driving through a geographic area and locations of a client computing device at different points in time in accordance with aspects of the disclosure.

FIG. 8 is an example of a vehicle driving through a geographic area and locations of a client computing device at different points in time in accordance with aspects of the disclosure.

FIG. 9 is an example of a vehicle driving through a geographic area and a new trajectory in accordance with aspects of the disclosure.

FIG. 10 is an example client computing device and displayed information in accordance with aspects of the disclosure.

FIG. 11 is an example flow diagram in accordance with aspects of the disclosure.

### DETAILED DESCRIPTION

### Overview

The technology relates to timing of pickups for autonomous vehicles. For instance, transportation services may be provided using a fleet of autonomous vehicles. Once an autonomous vehicle is dispatched to a location to pick up a passenger, the vehicle may control itself to that location. In some instances, the vehicle may arrive before the passenger. This may occur even when trips are scheduled well in advance and vehicles are dispatched immediately before the trip. In such instances, the vehicle may need to find a place to park and wait, and if there is no parking available nearby the location or no safe place to wait, may need to drive “around the block” until the passenger arrives in order to avoid blocking other traffic when double-parking. Such behaviors can add unnecessary congestion in terms of both traffic and parking in certain locations, especially in busier urban areas. In addition, this can make pickups more complex (e.g. it can become even more difficult for a passenger to find an assigned vehicle).

In order to enable better timing of pickups, once a passenger is assigned to a vehicle and the vehicle is on its way to a pickup location, the vehicle's computing devices or a remote computing device may receive location information for the passenger. This location information may include a location determined at the user's client computing device.

The location information may be sent by the client computing device automatically to the remote computing device. Once some triggering condition is met, the remote computing device may forward this information to the vehicle's computing devices or may automatically determine an estimated time of arrival for the passenger at the pickup location and may send this estimated time of arrival to the vehicle's computing devices.

Different triggering conditions may be used. As an example, a first triggering condition may be a change in the location of the passenger's client computing device that indicates the passenger has begun to move towards the pickup location. As another example, a second triggering condition may be some period of time before the vehicle is expected to reach the pickup location using its current route.

The location information may be converted to an estimated time of arrival for the passenger to reach the pickup location. In some instances, this estimated time of arrival may be adjusted upwards using additional contextual information.

After receiving the estimated time of arrival from the remote computing devices or determining it locally, the vehicle's computing devices may use the estimated time of arrival to plan its route to the pickup location. In this regard, the estimated time of arrival may be used to determine a route to the pickup location that will cause the vehicle to arrive at or close to the estimated time of arrival. Because the triggering conditions are such that the vehicle will likely only be a few minutes before the vehicle is to reach the pickup location, in addition to using the estimated time of arrival in route planning, the vehicle's computing devices may also use the estimated time of arrival to plan its trajectories for reaching the pickup location. By doing so, the vehicle's computing devices may be able to maneuver the vehicle to reach the pickup location as close to the estimated time of arrival as possible.

Once the vehicle is within some predetermined distance in time or space from the pickup location, the vehicle's computing devices may begin to look for a place to pull over and/or stop the vehicle to allow the passenger to enter the vehicle. Once this occurs, the vehicle may continue to the passenger's destination.

The features described herein may allow for better timing of pickups for autonomous vehicles and thereby improve the precision of each passenger pickup. By enabling vehicles to reach pickup locations as close as possible to when a passenger arrives, this may also reduce the likelihood of a vehicle needing to find a parking spot to wait for a passenger, minimize the time spent pulled over and waiting, and also reduce the likelihood of a vehicle needing to double park or drive around the block.

### Example Systems

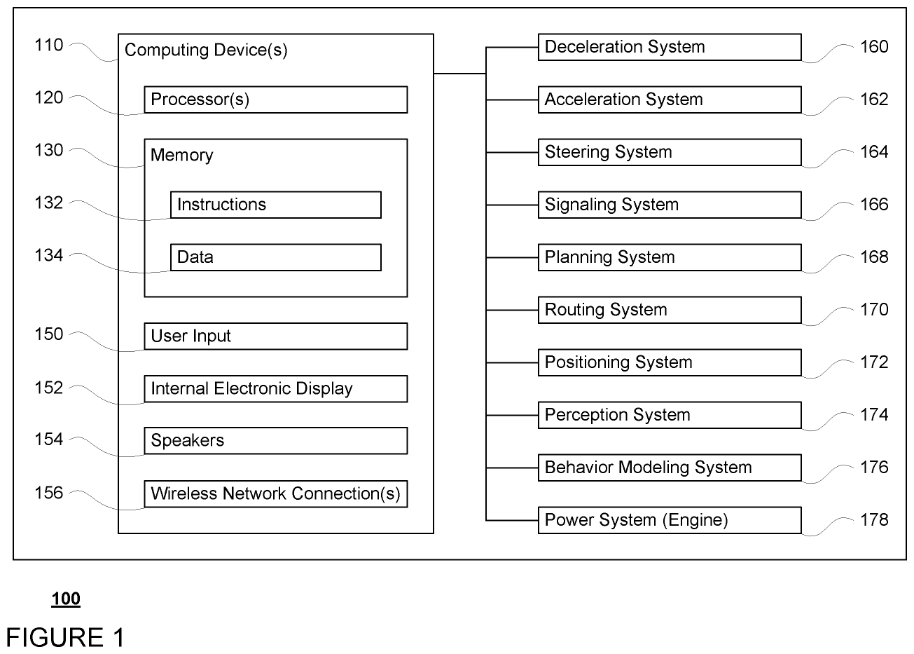

As shown in FIG. 1, a vehicle 100 in accordance with one aspect of the disclosure includes various components. While certain aspects of the disclosure are particularly useful in connection with specific types of vehicles, the vehicle may be any type of vehicle including, but not limited to, cars, trucks, motorcycles, buses, recreational vehicles, etc. The vehicle may have one or more computing devices, such as computing device 110 containing one or more processors 120, memory 130 and other components typically present in general purpose computing devices.

The memory 130 stores information accessible by the one or more processors 120, including instructions 134 and data 132 that may be executed or otherwise used by the processor 120. The memory 130 may be of any type capable of storing information accessible by the processor, including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 134 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The data 132 may be retrieved, stored or modified by processor 120 in accordance with the instructions 134. For instance, although the claimed subject matter is not limited by any particular data structure, the data may be stored in computing device registers, in a relational database as a table having a plurality of different fields and records, XML documents or flat files. The data may also be formatted in any computing device-readable format.

The one or more processor 120 may be any conventional processors, such as commercially available CPUs or GPUs. Alternatively, the one or more processors may be a dedicated device such as an ASIC or other hardware-based processor. Although FIG. 1 functionally illustrates the processor, memory, and other elements of computing device 110 as being within the same block, it will be understood by those of ordinary skill in the art that the processor, computing device, or memory may actually include multiple processors, computing devices, or memories that may or may not be stored within the same physical housing. For example, memory may be a hard drive or other storage media located in a housing different from that of computing device 110. Accordingly, references to a processor or computing device will be understood to include references to a collection of processors or computing devices or memories that may or may not operate in parallel.

Computing devices 110 may include all of the components normally used in connection with a computing device such as the processor and memory described above as well as a user input 150 (e.g., one or more button, mouse, keyboard, touch screen and/or microphone), various electronic displays (e.g., a monitor having a screen or any other electrical device that is operable to display information), and speakers 154 to provide information to a passenger of the vehicle 100 or others as needed. For example, electronic display 152 may be located within a cabin of vehicle 100 and may be used by computing devices 110 to provide information to passengers within the vehicle 100.

Computing devices 110 may also include one or more wireless network connections 156 to facilitate communication with other computing devices, such as the client computing devices and server computing devices described in detail below. The wireless network connections may include short range communication protocols such as Bluetooth, Bluetooth low energy (LE), cellular connections, as well as various configurations and protocols including the Internet, World Wide Web, intranets, virtual private networks, wide area networks, local networks, private networks using communication protocols proprietary to one or more companies, Ethernet, WiFi and HTTP, and various combinations of the foregoing.

The computing devices 110 may be part of an autonomous control system for the vehicle 100 and may be capable of communicating with various components of the vehicle in order to control the vehicle in an autonomous driving mode. For example, returning to FIG. 1, the computing devices 110 may be in communication with various systems of vehicle 100, such as deceleration system 160, acceleration system 162, steering system 164, signaling system 166, planning system 168, routing system 170, positioning system 172, perception system 174, behavior modeling system 176, and power system 178 in order to control the movement, speed, etc. of vehicle 100 in accordance with the instructions 134 of memory 130 in the autonomous driving mode.

As an example, the computing devices 110 may interact with deceleration system 160 and acceleration system 162 in order to control the speed of the vehicle. Similarly, steering system 164 may be used by computing devices 110 in order to control the direction of vehicle 100. For example, if vehicle 100 is configured for use on a road, such as a car or truck, the steering system may include components to control the angle of wheels to turn the vehicle. The computing devices 110 may also use the signaling system 166 in order to signal the vehicle's intent to other drivers or vehicles, for example, by lighting turn signals or brake lights when needed.

Routing system 170 may be used by the computing devices 110 in order to generate a route to a destination using map information. Planning system 168 may be used by computing device 110 in order to generate short-term trajectories that allow the vehicle to follow routes generated by the routing system. In this regard, the planning system 168 and/or routing system 166 may store detailed map information, e.g., highly detailed maps identifying a road network including the shape and elevation of roadways, lane lines, intersections, crosswalks, speed limits, traffic signals, buildings (including types or categories, footprints, number of stories, floors, levels, etc.), signs, real time traffic information (updated as received from a remote computing device, as such as the computing devices 410 discussed below or other computing devices), pullover spots, vegetation, or other such objects and information.

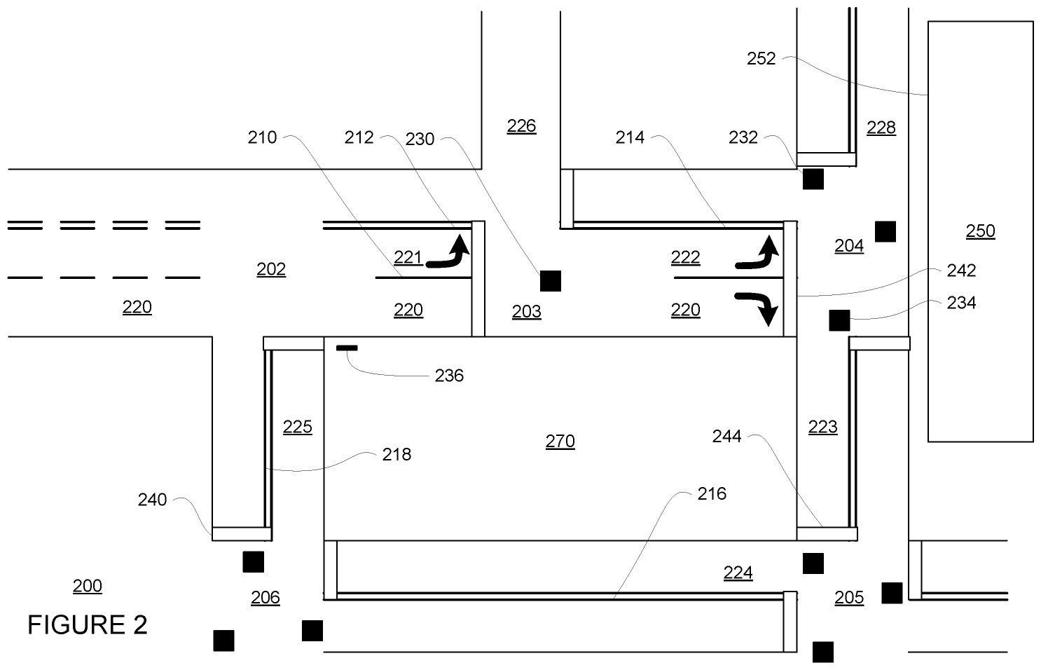

FIG. 2 is an example of map information 200 for a small section of roadway including intersections 202, 203, 204, 205, 206. FIG. 2A depicts a portion of the map information 200 that includes information identifying the shape, location, and other characteristics of lane markers or lane lines 210, 212, 214, 216, 218, lanes 220, 221, 222, 223, 224, 225, 226, 228, traffic control devices including traffic signal lights 230, 232, 234 and stop sign 236, stop lines 240, 242, 244, as well as a non-drivable area 270. In this example, lane 221 approaching intersection 204 is a left turn only lane, lane 222 approaching intersection 206 is a left turn only lane, and lane 226 is a one-way street where the direction of traffic moves away from intersection 204. In this example, the map information 200 also identifies a footprint 252 of a building 250. Although shown in two dimensions, the footprint may also be a three-dimensional area occupied by the building. This may also be associated with additional information identifying a classification or type of the building and/or a number of stories, floors or levels. For example, building 250 may be a retail business with two stories. In addition to the aforementioned features and information, the map information may also include information that identifies the direction of traffic for each lane as well as information that allows the computing devices 110 to determine whether the vehicle has the right of way to complete a particular maneuver (i.e. complete a turn or cross a lane of traffic or intersection).

In addition to the aforementioned physical feature information, the map information may include a plurality of graph nodes and edges representing road or lane segments that together make up the road network of the map information. Each edge is defined by a starting graph node having a specific geographic location (e.g. latitude, longitude, altitude, etc.), an ending graph node having a specific geographic location (e.g. latitude, longitude, altitude, etc.), and a direction. This direction may refer to a direction the vehicle 100 must be moving in in order to follow the edge (i.e. a direction of traffic flow). The graph nodes may be located at fixed or variable distances. For instance, the spacing of the graph nodes may range from a few centimeters to a few meters and may correspond to the speed limit of a road on which the graph node is located. In this regard, greater speeds may correspond to greater distances between graph nodes. The edges may represent driving along the same lane or changing lanes. Each node and edge may have a unique identifier, such as a latitude and longitude location of the node or starting and ending locations or nodes of an edge. In addition to nodes and edges, the map may identify additional information such as types of maneuvers required at different edges as well as which lanes are drivable.

The routing system 166 may use the aforementioned map information to determine a route from a current location (e.g. a location of a current node) to a destination. Routes may be generated using a cost-based analysis which attempts to select a route to the destination with the lowest cost. Costs may be assessed in any number of ways such as time to the destination, distance traveled (each edge may be associated with a cost to traverse that edge), types of maneuvers required, convenience to passengers or the vehicle, etc. Each route may include a list of a plurality of nodes and edges which the vehicle can use to reach the destination. Routes may be recomputed periodically as the vehicle travels to the destination.

The map information used for routing may be the same or a different map as that used for planning trajectories. For example, the map information used for planning routes not only requires information on individual lanes, but also the nature of lane boundaries (e.g., solid white, dash white, solid yellow, etc.) to determine where lane changes are allowed. However, unlike the map used for planning trajectories, the map information used for routing need not include other details such as the locations of crosswalks, traffic lights, stop signs, etc., though some of this information may be useful for routing purposes. For example, between a route with a large number of intersections with traffic controls (such as stop signs or traffic signal lights) versus one with no or very few traffic controls, the latter route may have a lower cost (e.g. because it is faster) and therefore be preferable.

Positioning system 170 may be used by computing devices 110 in order to determine the vehicle's relative or absolute position on a map or on the earth. For example, the positioning system 170 may include a GPS receiver to determine the device's latitude, longitude and/or altitude position. Other location systems such as laser-based localization systems, inertial-aided GPS, or camera-based localization may also be used to identify the location of the vehicle. The location of the vehicle may include an absolute geographical location, such as latitude, longitude, and altitude, a location of a node or edge of the roadgraph as well as relative location information, such as location relative to other cars immediately around it which can often be determined with less noise that absolute geographical location.

The positioning system 172 may also include other devices in communication with the computing devices computing devices 110, such as an accelerometer, gyroscope or another direction/speed detection device to determine the direction and speed of the vehicle or changes thereto. By way of example only, an acceleration device may determine its pitch, yaw or roll (or changes thereto) relative to the direction of gravity or a plane perpendicular thereto. The device may also track increases or decreases in speed and the direction of such changes. The device's provision of location and orientation data as set forth herein may be provided automatically to the computing device 110, other computing devices and combinations of the foregoing.

The perception system 174 also includes one or more components for detecting objects external to the vehicle such as other vehicles, obstacles in the roadway, traffic signals, signs, trees, etc. For example, the perception system 174 may include lasers, sonar, radar, cameras and/or any other detection devices that record data which may be processed by the computing devices of the computing devices 110. In the case where the vehicle is a passenger vehicle such as a minivan, the minivan may include a laser or other sensors mounted on the roof or other convenient location.

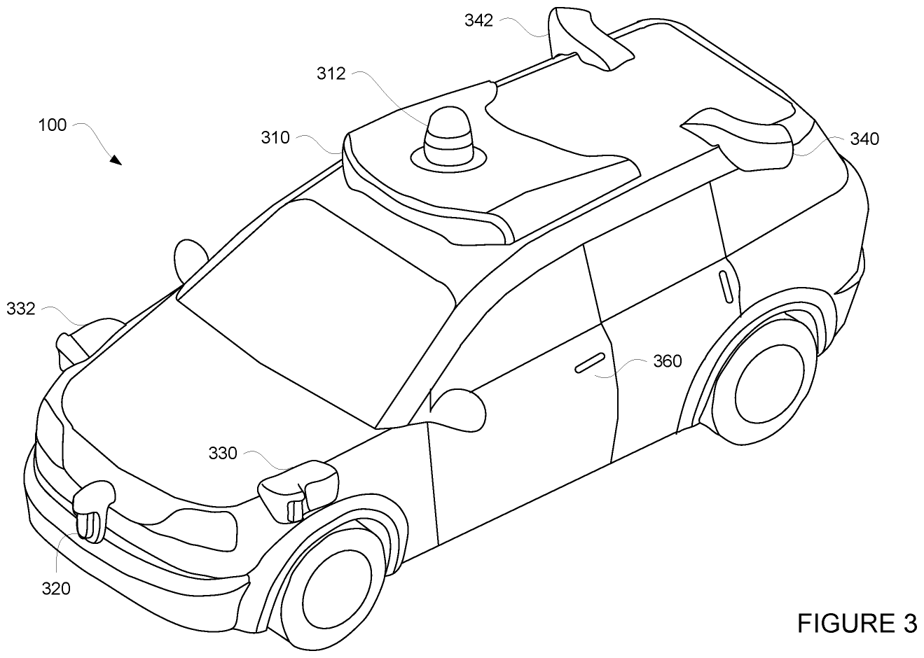

For instance, FIG. 3 is an example external view of vehicle 100. In this example, roof-top housing 310 and dome housing 312 may include a LIDAR sensor as well as various cameras and radar units. In addition, housing 320 located at the front end of vehicle 100 and housings 330, 332 on the driver's and passenger's sides of the vehicle may each store a LIDAR sensor. For example, housing 330 is located in front of driver door 360. Vehicle 100 also includes housings 340, 342 for radar units and/or cameras also located on the roof of vehicle 100. Additional radar units and cameras (not shown) may be located at the front and rear ends of vehicle 100 and/or on other positions along the roof or roof-top housing 310.

The computing devices 110 may be capable of communicating with various components of the vehicle in order to control the movement of vehicle 100 according to primary vehicle control code of memory of the computing devices 110. For example, returning to FIG. 1, the computing devices 110 may include various computing devices in communication with various systems of vehicle 100, such as deceleration system 160, acceleration system 162, steering system 164, signaling system 166, planning system 168, routing system 170, positioning system 172, perception system 174, behavior modeling system 176, and power system 178 (i.e. the vehicle's engine or motor) in order to control the movement, speed, etc. of vehicle 100 in accordance with the instructions 134 of memory 130.

The various systems of the vehicle may function using autonomous vehicle control software in order to determine how to and to control the vehicle. As an example, a perception system software module of the perception system 174 may use sensor data generated by one or more sensors of an autonomous vehicle, such as cameras, LIDAR sensors, radar units, sonar units, etc., to detect and identify objects and their characteristics. These characteristics may include location, type, heading, orientation, speed, acceleration, change in acceleration, size, shape, etc. In some instances, characteristics may be input into a behavior prediction system software module of the behavior modeling system 176 which uses various behavior models based on object type to output a predicted future behavior for a detected object. In other instances, the characteristics may be put into one or more detection system software modules, such as a traffic light detection system software module configured to detect the states of known traffic signals, construction zone detection system software module configured to detect construction zones from sensor data generated by the one or more sensors of the vehicle as well as an emergency vehicle detection system configured to detect emergency vehicles from sensor data generated by sensors of the vehicle. Each of these detection system software modules may use various models to output a likelihood of a construction zone or an object being an emergency vehicle. Detected objects, predicted future behaviors, various likelihoods from detection system software modules, the map information identifying the vehicle's environment, position information from the positioning system 170 identifying the location and orientation of the vehicle, a destination location or node for the vehicle as well as feedback from various other systems of the vehicle may be input into a planning system software module of the planning system 168. The planning system 168 may use this input to generate trajectories for the vehicle to follow for some brief period of time into the future based on a route generated by a routing module of the routing system 170. In this regard, the trajectories may define the specific characteristics of acceleration, deceleration, speed, etc. to allow the vehicle to follow the route towards reaching a destination. A control system software module of the computing devices 110 may be configured to control movement of the vehicle, for instance by controlling braking, acceleration and steering of the vehicle, in order to follow a trajectory.

The computing devices 110 may control the vehicle in an autonomous driving mode by controlling various components. For instance, by way of example, the computing devices 110 may navigate the vehicle to a destination location completely autonomously using data from the detailed map information and planning system 168. The computing devices 110 may use the positioning system 170 to determine the vehicle's location and perception system 174 to detect and respond to objects when needed to reach the location safely. Again, in order to do so, computing device 110 and/or planning system 168 may generate trajectories and cause the vehicle to follow these trajectories, for instance, by causing the vehicle to accelerate (e.g., by supplying fuel or other energy to the engine or power system 178 by acceleration system 162), decelerate (e.g., by decreasing the fuel supplied to the engine or power system 178, changing gears, and/or by applying brakes by deceleration system 160), change direction (e.g., by turning the front or rear wheels of vehicle 100 by steering system 164), and signal such changes (e.g., by lighting turn signals) using the signaling system 166. Thus, the acceleration system 162 and deceleration system 160 may be a part of a drivetrain that includes various components between an engine of the vehicle and the wheels of the vehicle. Again, by controlling these systems, computing devices 110 may also control the drivetrain of the vehicle in order to maneuver the vehicle autonomously.

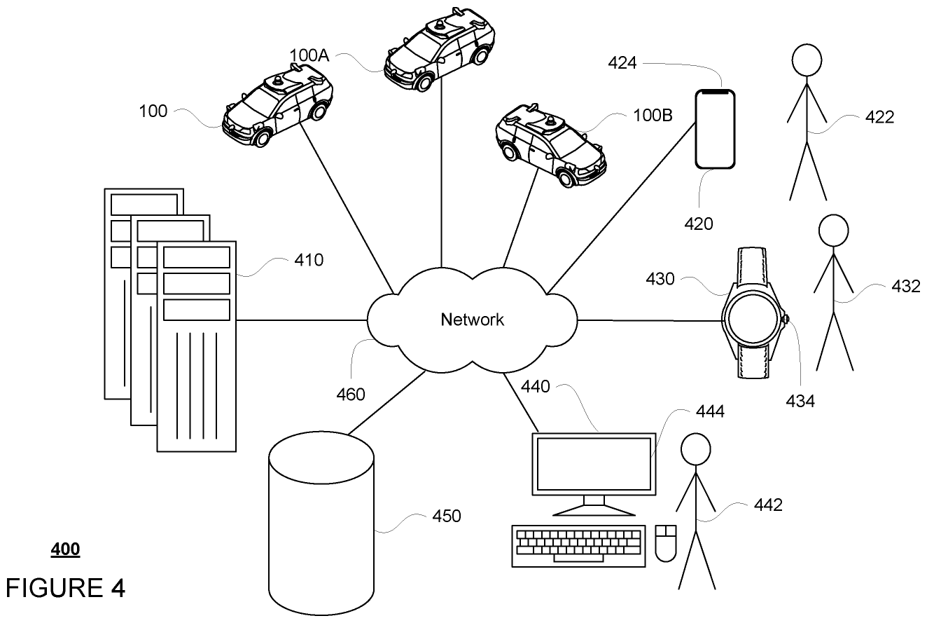

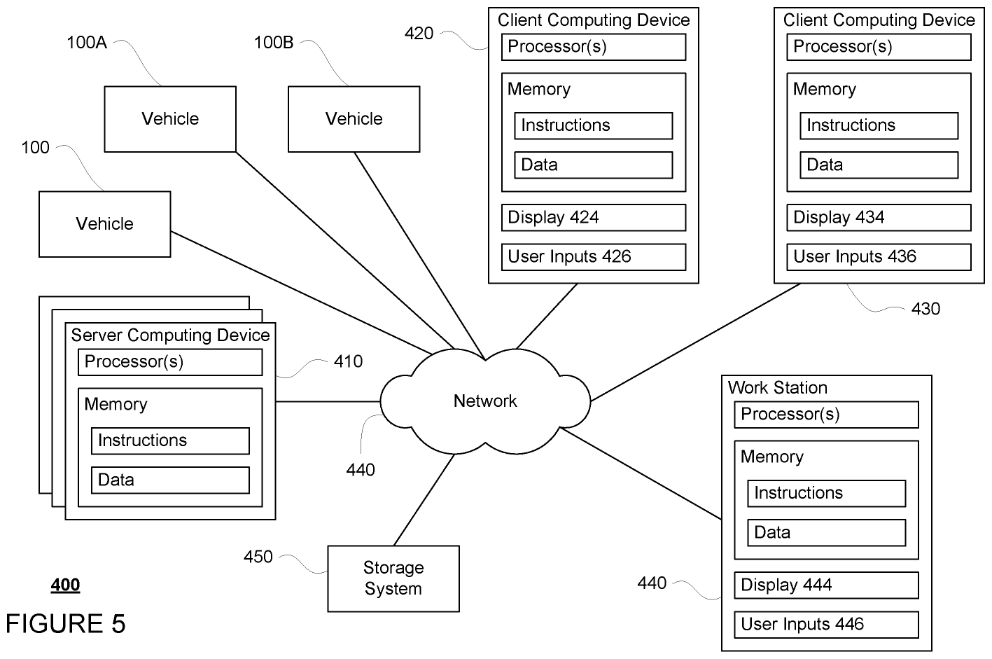

Computing device 110 of vehicle 100 may also receive or transfer information to and from other computing devices, such as those computing devices that are a part of the transportation service as well as other computing devices. FIGS. 4 and 5 are pictorial and functional diagrams, respectively, of an example system 400 that includes a plurality of computing devices 410, 420, 430, 440 and a storage system 450 connected via a network 460. System 400 also includes vehicle 100A and vehicle 100B, which may be configured the same as or similarly to vehicle 100. Although only a few vehicles and computing devices are depicted for simplicity, a typical system may include significantly more.

As shown in FIG. 5, each of computing devices 410, 420, 430, 440 may include one or more processors, memory, data and instructions. Such processors, memories, data and instructions may be configured similarly to one or more processors 120, memory 130, data 132, and instructions 134 of computing device 110.

The network 460, and intervening graph nodes, may include various configurations and protocols including short range communication protocols such as Bluetooth, Bluetooth LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, one or more computing devices 410 may include one or more server computing devices having a plurality of computing devices, e.g., a load balanced server farm, that exchange information with different nodes of a network for the purpose of receiving, processing and transmitting the data to and from other computing devices. For instance, one or more computing devices 410 may include one or more server computing devices that are capable of communicating with computing device 110 of vehicle 100 or a similar computing device of vehicle 100A or vehicle 100B as well as computing devices 420, 430, 440 via the network 460. For example, vehicles 100, 100A, 100B, may be a part of a fleet of vehicles that can be dispatched by server computing devices to various locations. In this regard, the server computing devices 410 may function as a fleet management system which can be used to dispatch vehicles such as vehicles 100, 100A, 100B to different locations in order to pick up and drop off passengers. In addition, the computing devices 410 may use network 460 to transmit and present information to a user, such as user 422, 432, 442 on a display, such as displays 424, 434, 444 of computing devices 420, 430, 440. In this regard, computing devices 420, 430, 440 may be considered client computing devices.

The server computing devices 410 may also track the state of the vehicles of the fleet using information that is periodically broadcast by the vehicles, specifically requested by the server computing devices provided by the vehicles, or using other methods of tracking the states of a fleet of autonomous vehicles. This periodically broadcast information may include messages providing all state information for a given vehicle. For instance state messages may be self-consistent and generated based on rules about packaging the messages from various systems of the vehicles. As an example, the messages may include vehicle pose (position/location and orientation), lane information (i.e., in what lane the vehicle is currently traveling), current route, estimated time of arrival at the vehicle's current destination (e.g. how long to reach a pickup or destination location for a passenger), as well as other information, such as whether the vehicle is currently providing transportation services, experiencing any errors or problems, etc. In this regard, the server computing devices 410 may track the vehicle's progress with regard to its current route as well as estimate when the vehicle is likely to arrive at the vehicle's current destination. This state information may be stored, for example, in the storage system 450.

As shown in FIG. 4, each client computing device 420, 430 may be a personal computing device intended for use by a user 422, 432 and have all of the components normally used in connection with a personal computing device including a one or more processors (e.g., a central processing unit (CPU)), memory (e.g., RAM and internal hard drives) storing data and instructions, a display such as displays 424, 434, 444 (e.g., a monitor having a screen, a touch-screen, a projector, a television, or other device that is operable to display information), and user input devices 426, 436, 446 (e.g., a mouse, keyboard, touchscreen or microphone). The client computing devices may also include a camera for recording video streams, speakers, a network interface device, and all of the components used for connecting these elements to one another.

Although the client computing devices 420, 430 may each comprise a full-sized personal computing device, they may alternatively comprise mobile computing devices capable of wirelessly exchanging data with a server over a network such as the Internet. By way of example only, client computing device 420 may be a mobile phone or a device such as a wireless-enabled PDA, a tablet PC, a wearable computing device or system, or a netbook that is capable of obtaining information via the Internet or other networks. In another example, client computing device 430 may be a wearable computing system, shown as a wristwatch as shown in FIG. 5. As an example the user may input information using a small keyboard, a keypad, microphone, using visual signals with a camera, or a touch screen.

As with memory 130, storage system 450 can be of any type of computerized storage capable of storing information accessible by the server computing devices 410, such as a hard-drive, memory card, ROM, RAM, DVD, CD-ROM, write-capable, and read-only memories. In addition, storage system 450 may include a distributed storage system where data is stored on a plurality of different storage devices which may be physically located at the same or different geographic locations. Storage system 450 may be connected to the computing devices via the network 460 as shown in FIGS. 3 and 4, and/or may be directly connected to or incorporated into any of the computing devices 110, 410, 420, 430, 440, etc.

Storage system 450 may store various types of information as described in more detail below. This information may be retrieved or otherwise accessed by a server computing device, such as one or more server computing devices 410, in order to perform some or all of the features described herein. For instance, the storage system may store the aforementioned tracked statuses of the vehicles of the fleet of autonomous vehicles as discussed above as well as information about vehicles assigned to users for trips.

### Example Methods

In addition to the operations described above and illustrated in the figures, various operations will now be described. It should be understood that the following operations do not have to be performed in the precise order described below. Rather, various steps can be handled in a different order or simultaneously, and steps may also be added or omitted.

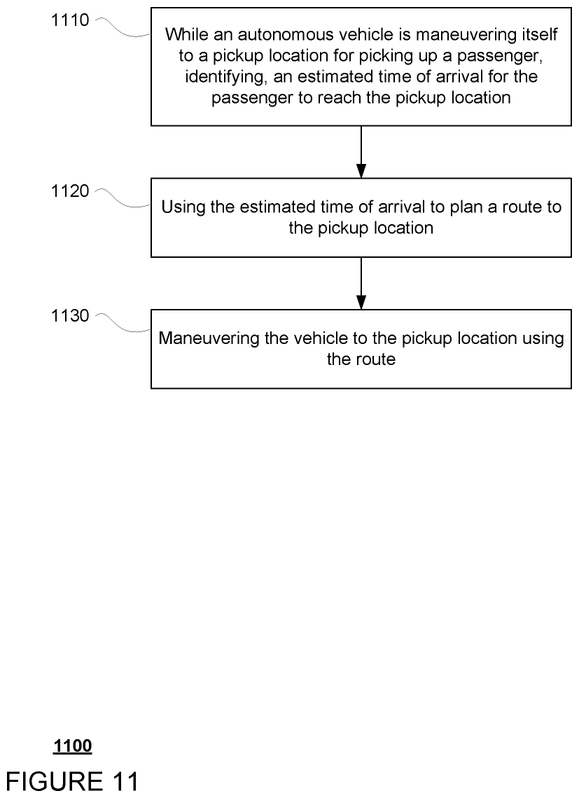

FIG. 11 is an example flow diagram 1100 for timing pickups of passengers for autonomous vehicles, which may be performed by one or more processors of one or more computing devices, such as the processors 120 of the vehicle 100 and/or the processors of the server computing devices 410 as indicated below. At block 1110, while an autonomous vehicle is maneuvering itself to a pickup location for picking up a passenger, an estimated time of arrival for the passenger to reach the pickup location is identified.

In one aspect, a user may download an application for requesting a vehicle to a client computing device. For example, users 422 and 432 may download the application via a link in an email, directly from a website, or an application store to client computing devices 420 and 430. For example, a client computing device may transmit a request for the application over the network 460, for example, to one or more server computing devices 110, and in response, receive the application. The application may be installed locally at the client computing device.

A user, such as user 422, may input a destination location for a trip into a client computing device, such as client computing device 420, via an application, and the application may send a signal identifying the destination location to one or more server computing devices 410. This destination location may be defined as an address, a name (e.g. a business name), a type of business (e.g. a hardware store), etc. In some instances, the user may also identify one or more intermediate destinations in a similar manner.

The user may also specify or otherwise provide a pickup location at which a vehicle can pick up the vehicle. As an example, a pickup location can be defaulted to a current location of the passenger's client computing device, but may also be a recent, suggested, or saved location near the current location associated with the user's account. The user may enter an address or other location information, tap a location on a map or select a location from a list in order to identify a pickup location. For instance, the client computing device 420 by way of the application may send its current location, such as a GPS location, and/or a name, address or other identifier for the pickup location to the one or more server computing devices 410 via network 460. In this regard, the user may share his or her current location (or other information such as accelerometer or gyroscope information generated by such devices at the client computing device) with the server computing devices 410 when using the application and/or requesting a vehicle for a trip.

In response to receiving the pickup location, destination location and any intermediate destination locations, the server computing devices 410, may request the user to confirm the trip (e.g. confirm the details of the trip). Once confirmation is received from the client computing device 420, the server computing devices 410 may dispatch an autonomous vehicle to pick up the user 422 and complete the trip. To do so, the server computing devices 410 may first select an autonomous vehicle, for instance based on proximity to the pickup location and/or availability, and assign the autonomous vehicle to the user for the trip. For example, the server computing devices 410 may determine that vehicle 100 is available and closest to the location of the passenger (user 422).

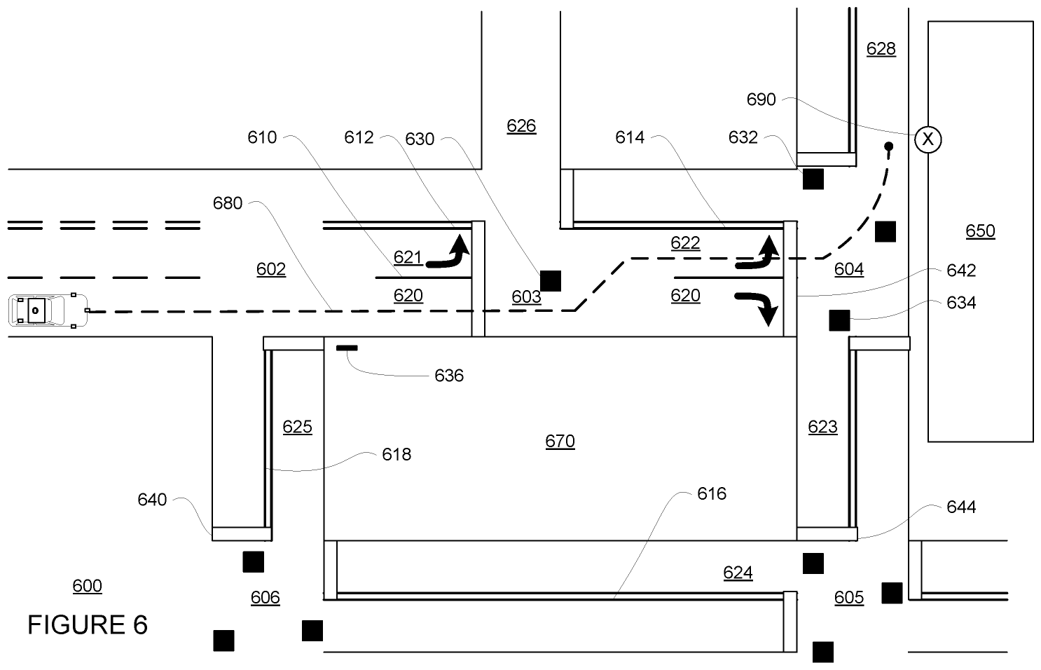

FIG. 6 is an example of vehicle 100 driving through a geographic area 600 corresponding to the area of the map information 200 depicted in FIG. 2. In this example, the shape, location and other characteristics of intersections 602, 603, 604, 605, 606 correspond to intersections 202, 203, 204, 205, 206, the shape, location and other characteristics of lane lines 610, 612, 614, 616, 618 correspond to lane lines 210, 212, 214, 216, 218, the shape, location and other characteristics of lanes 620, 621, 622, 623, 624, 625, 626, 628 correspond to lanes 220, 221, 222, 223, 224, 225, 226, 228, the shape, location and other characteristics of traffic control devices including traffic signal lights 630, 632, 634 and stop sign 636 correspond to traffic signal lights 230, 232, 234 and stop sign 236, the shape, location and other characteristics of stop lines 640, 642, 644 correspond to stop lines 240, 242, 244, the shape, location and other characteristics of building 650 correspond to building 250, and the shape, location and other characteristics of area 670 correspond to non-drivable area 270.

In this example, vehicle 100 is in lane 620 approaching intersection 603 and is following route 680 (e.g. a fastest route) to a destination, here pickup location 690, in order to pick up the user 422. The route takes the vehicle 100 through intersection 603 and into lane 622 from which the vehicle would make a left-hand turn at intersection 604 into lane 628 in order to reach the pickup location 690. Of course, this route would be defined relative to the map information 200 and from this perspective, the vehicle 100 would travel through intersection 203 and into lane 222 from which the vehicle would make a left-hand turn at intersection 204 into lane 228 in order to reach the pickup location 690.

The dispatching may involve the server computing devices 410 sending a signal to the autonomous vehicle 100, in particular to the computing devices 110, via the network 460 identifying the destination location and any intermediate destination location as destination locations for the trip as well as a pickup location for picking up the user 422. This, in turn, may cause the computing devices 110 of the vehicle 100 to automatically control the vehicle to the pickup location and the destination location autonomously (e.g. in an autonomous driving mode) as described above.

In order to enable better timing of pickups, once a user (now a passenger) is assigned to a vehicle and the vehicle has been dispatched (e.g. the vehicle 100 is on its way to a pickup location), the server computing devices 410 may receive location information for the passenger. This location information may include a location determined at the passenger's client computing device. For example, the location may be a GPS-based location or some other location determined at the client computing device 420. In this regard, the application may periodically send the location determined at the client computing device 420 to the server computing devices 410 via the network 460 once the user has confirmed the trip.

Once some triggering condition is met, an estimated time of arrival for the passenger to reach the pickup location may be determined. In some instances, the server computing devices 410 may forward the location information received from the client computing device 420 to the computing devices 110. In addition or alternatively, once a triggering condition is met, the server computing devices 410 may automatically determine an estimated time of arrival for the passenger at the pickup location and may send this estimated time of arrival to the vehicle's computing devices. In this regard, the determination of an estimated time of arrival may occur only at the server computing devices 410, only at the vehicle's computing devices 110, or both.

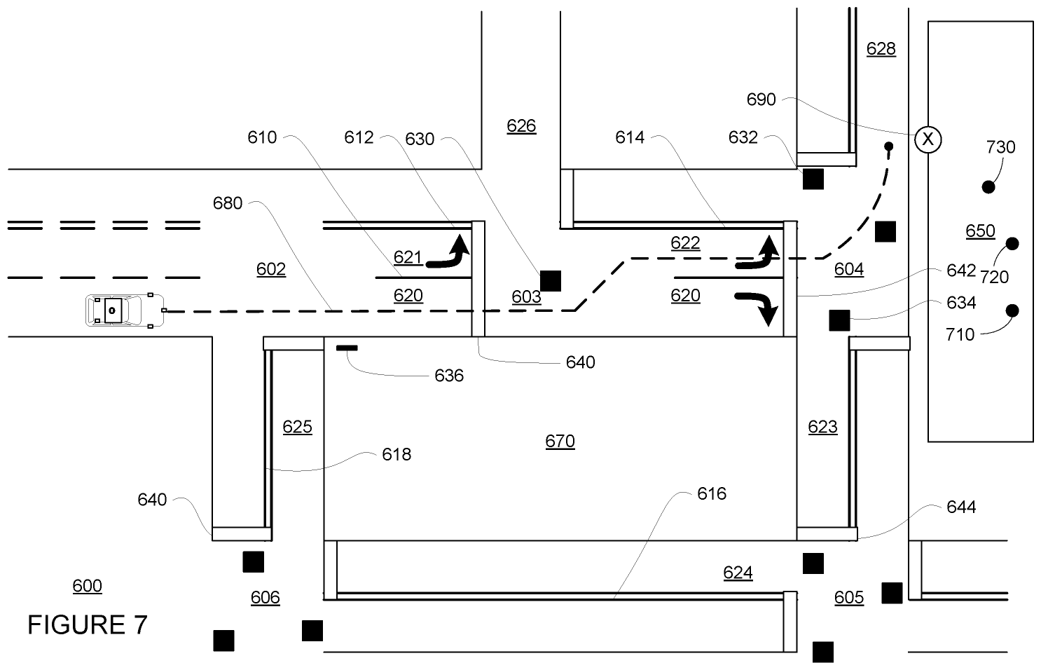

Different triggering conditions may be used. As an example, a first triggering condition may be a change in the location of the passenger's client computing device that indicates the passenger has begun to move towards the pickup location. The server computing devices 410 may determine when the first triggering condition has been met by determining whether changes in the location indicated that the passenger was walking as compared to being stationary (e.g. standing or sitting), that the passenger is moving towards known entry or exit points from the building, stairwells or elevators (e.g. determined by comparing to the map information), if the changes in the location indicate a change in a walking speed of the passenger as well as a trajectory that indicates that the passenger is moving towards the pickup location, if there is a combination of changes in the location and gate (e.g. from accelerometer or gyroscope information provided to the server computing devices 410 by the client computing device via the application) while the passenger has the application open and/or is viewing a map in the application, etc. FIG. 7 depicts an example 700 of locations 710, 720, 730 of the client computing device 420 at three different points in time; T1, T2, and T3, respectively. In this example, T1 occurs before T2, and T2 occurs before. As such, the locations 710 (at T1), 720 (at T2), 730 (at T3) would indicate that the client computing device 420, and therefore also very likely the user 422, is approaching the pickup location 690. Thus, in this example, at time T3, the triggering condition of the user 422 moving towards the pickup location 690 is met.

However, in some instances, the first triggering condition may not necessarily occur until immediately before the passenger expects that the vehicle will arrive. As such, a second triggering condition corresponding to a minimum period of time before the vehicle is expected to reach the pickup location using its current route, such as 2-3 minutes before or more or less, may be used. The server computing devices 410 may determine when the second triggering condition has been met based on the aforementioned state messages received from the vehicle 100 and/or the status information stored in the storage system 450. This combination of using the first and second triggering conditions may avoid waiting too long before attempting to determine an estimated time of arrival or unnecessarily tracking the passenger's location earlier than necessary.

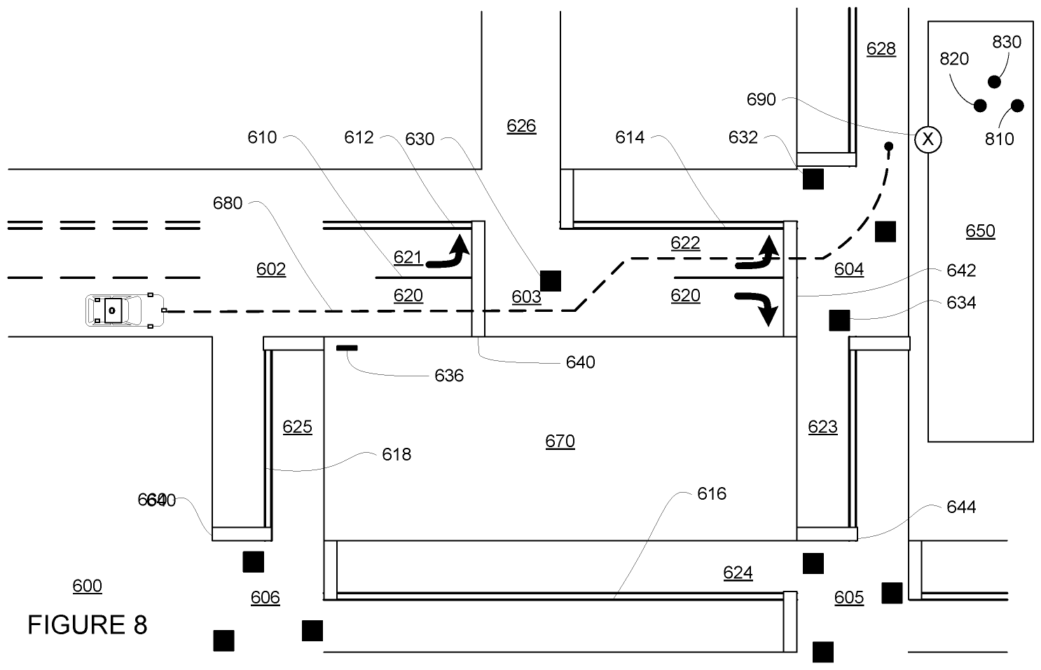

FIG. 8 depicts an example 800 which is an alternative to the example 700. In this example, the first triggering condition has not been met. For instance, locations 810, 820, 830 of the client computing device 420 occur at three different points in time; T4, T5, and T6, respectively. In this example, T4 occurs before T5, and T5 occurs before. As such, the locations 810 (at T4), 820 (at T5), 830 (at T6) would indicate that the client computing device 420, and therefore very likely the user 422, is not approaching the pickup location 690. However, at this point in time, the vehicle 100 has an estimated time of arrival at the pickup location 690 of 2 minutes, which meets the second triggering condition. Thus, in this example, at time T3, the second triggering condition of a minimum period of time before the vehicle is expected to reach the pickup location using its current route.

As noted above, the location information may be converted to or used to determine an estimated time of arrival for the passenger to reach the pickup location. In some instances, this conversion may be as simple as determining a “straight-line” distance between the passenger's location and the pickup location. This distance (D) may then be converted to an estimated time of arrival using an average or expected walking speed for a pedestrian (P). In other words, an estimated time of arrival (T) may be determined using the simple equation T=D*P. In this example, P might be a fixed value such as 5.0 kilometers per hour (km/h), 1.4 meters per second (m/s), or 3.1 miles per hour (mph) or might vary depending on the classification of the pickup location. As an example, an estimated walking speed may be determined based on historical data for pickups at the same pickup location or similarly situated location. For example, if the pickup location is at a mall, a shopping center, or airport the value for P may be determined by the average walking speed for pickups at malls, shopping centers or airports, respectively or similarly situated malls, shopping centers or airports.

In some instances, this estimated time of arrival may be adjusted, typically upwards, using additional contextual information. For instance, if the location information indicates that the passenger is currently in a building or rather, within an outline of a footprint or a 3D space occupied by a building, additional time (B) may be added to allow for the passenger to exit the building. The value of B may be a fixed value, or may be determined based upon the time of day, day of week, month, season, etc. For instance, some third-party sources may provide corresponding information about how busy a particular As an example, an estimated time of arrival may be determined using the simple equation T=D*P+B. Information about the footprints or 3D spaces of buildings may be determined from the map information local to the vehicle 100 and/or the server computing devices 410. For example, the locations 710, 720, 730, 810, 820, 830 of the client computing device 420 is within the building 650 which corresponds to being within the footprint 252 of building 250. The value of B may be a fixed value, such as 10 seconds or more or less, when a passenger is within a building. Of course, other values may be used.

In addition or alternatively, additional time may be added based on the number of stories, floors or levels the building has. For example, as the number of stories, floors, or levels increases, the amount of additional time (S) may be added to the estimated time of arrival may also increase. As an example, an estimated time of arrival may be determined using the simple equation T=D*P+S. Again information about the number of stories, floors, or levels a building has may be determined from the map information local to the vehicle 100 and/or the server computing devices 410. For example, the locations 710, 720, 730, 810, 820, 830 of the client computing device 420 is within the building 650 which corresponds to being within the footprint 252 of building 250. As the building 250 has two levels, this information may be used to add additional time to the estimated time of arrival. For example, S may be a default value, such as 13 seconds or 37 seconds or more or less, depending upon whether the building includes only stairs or an elevator, respectively, and for each additional level, an additional fixed period of time, such as 13 seconds or more or less, may be added. Again information about whether a building includes stairs and/or an elevator may be included in the map information.

In addition or alternatively, additional time may be added based on the classification or type of the building. For example, if the building is an airport, stadium or other such venue, additional time (C) may be added as the passenger may need to wind his or her way around to the exit. Similarly, if the building is a shopping center, a passenger may be carrying groceries or other goods, and thus, additional time may be added. Along the same lines, if the building is an apartment building or a house, no additional time may be added. As an example, an estimated time of arrival may be determined using the equation T=D*W+C. The value of C may be a fixed value, such as 0.9 seconds or more or less. Of course, other values may be used. Again, information about the classification or type of a building may be determined from the map information local to the vehicle 100 and/or the server computing devices 410. For example, the locations 710, 720, 730, 810, 820, 830 of the client computing device 420 are each within the building 650 which corresponds to being within the footprint 252 of building 250. As the building 250 is classified as a retail business, this information may be used to add additional time to the estimated time of arrival

In addition or alternatively, additional time may be added based upon current weather conditions. For example, additional time may be added when it is raining or snowing in the form of a multiplier (W) greater than 1. As an example, an estimated time of arrival (T) may be determined using the equation T=D*P*W. Information about weather conditions may come from sensors of vehicles (e.g. from the aforementioned periodically broadcast information), third party weather sources, etc. In addition, the value of W may change depending upon the type of weather.

In addition or alternatively, additional time may be added based upon the current time of day given expected lighting conditions. For example, additional time may be added when it is dark out (i.e. at night), for instance, using a multiplier (L) less than 1, as a passenger may be more eager to reach a vehicle when it is dark for safety or other reasons. In this regard, the amount of time may actually be reduced. As an example, an estimated time of arrival (T) may be determined using the equation T=D*P*L. Information about lighting conditions may be inferred from the time of day and time of the year. For example, it tends to get darker earlier in the Northern Hemisphere in winter months as compared to summer months.

In addition or alternatively, additional time may be added based upon current congestion conditions. For example, additional time (V) may be added when there is a lot of traffic (either vehicular or pedestrian) in the area of the pickup location as the passenger may simply need more time to navigate to the pickup location. As an example, an estimated time of arrival (T) may be determined using the equation T=D*P+V. As an example, V may be 1 minute or more or less, and may be increased as the volume of traffic increases. Information about traffic conditions may be determined, for example, from sensor data (e.g. which may be received in the aforementioned periodically broadcasted reports), historical trends, third party traffic sources, etc.

Any of the aforementioned examples of contextual information may be added in conjunction with one another in order to provide a more accurate estimated time of arrival. For example, an estimated time of arrival may be determined using the equation T=(D*P+(B+S+C+V))*W*L. In this regard, if any values for B, S, C, and V are unknown, they may be set to zero, and if any values for W or L are unknown, they may be set to 1.

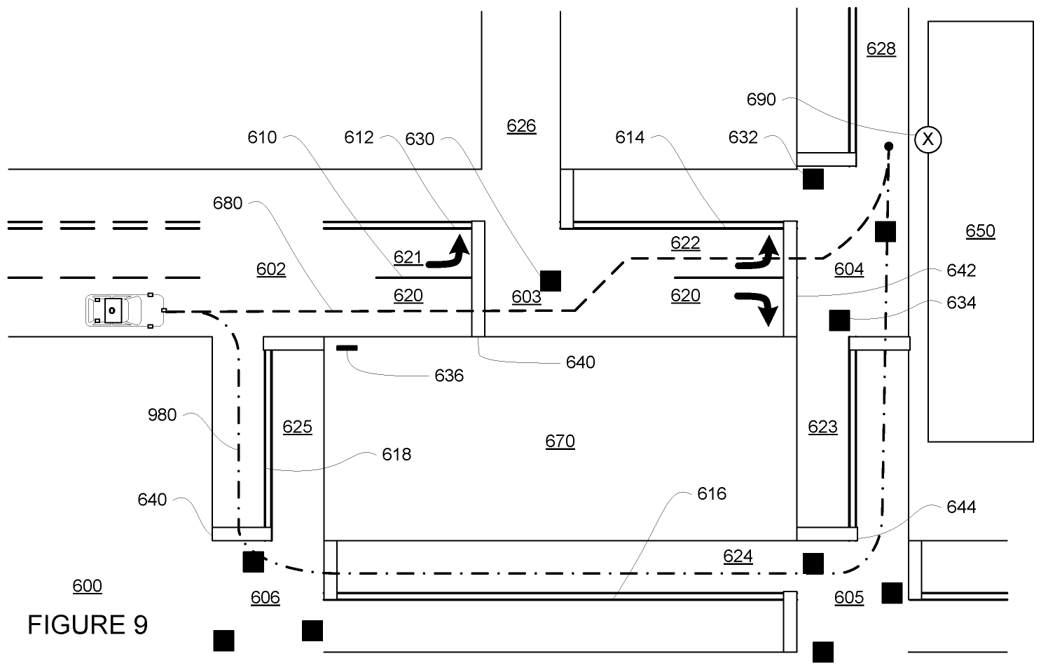

Returning to FIG. 11, at block 1120, the estimated time of arrival is used to plan a route to the pickup location. After receiving the estimated time of arrival from the remote computing devices or determining it locally, the computing devices 110 may use the estimated time of arrival to plan its route to the pickup location. In this regard, the estimated time of arrival may be used by the routing system 170 to determine a new route to the pickup location that will cause the vehicle 100 to arrive at or close as close as possible to the estimated time of arrival. FIG. 9 depicts an example of a new route 980 to the pickup location 690. This new route takes the vehicle around the area 670/non-drivable area 270, by making a right turn at intersection 602, 202, thereafter making a left turn at intersection 606, 206 in to lane 624, 224, and finally making a left turn at intersection 605, 205 into lane 628, 228 in order to reach the pickup location 690. The new route 980 is longer than the route 680, and thus, may take the vehicle 100 longer to reach the pickup location 690. At the same time, the new route 980 may allow the vehicle 100 to reach the pickup location 690 at or as close as possible to the estimated time of arrival, and also closer to the estimated time of arrival than the route 680.

Because the triggering conditions are such that that the vehicle 100 will likely only be a few minutes before the vehicle is to reach the pickup location, in addition to using the estimated time of arrival in route planning, the planning system 168 may also use the estimated time of arrival to plan its trajectories, and specifically, the vehicle's speed plans, for reaching the pickup location. In this regard, the vehicle's route may not necessarily change, but the vehicle may be controlled to drive slower as it approaches the pickup location. As an example, routing may involve adding a cost to routes that would result in the vehicle reaching the pickup location earlier than the estimated time of arrival. When a route would cause a vehicle to reach the pickup location may be determined based on typical consideration such as distances, speed limits, traffic conditions (currently perceived traffic conditions by the vehicle, currently received traffic conditions from a remote source, and/or historical traffic conditions for the same or similar time of day, day of week, day of year, etc.), etc. In this way, routes that would reach the pickup location closer to the estimated time of arrival may end up having lower overall costs and may be more likely to be selected and published by the routing system. By doing so, the vehicle's computing devices may be able to maneuver the vehicle to reach the pickup location as close to the estimated time of arrival as possible.

Returning to FIG. 11, at block 1130, the vehicle is maneuvered to the pickup location using the route. For example, Once the vehicle 100 is within some predetermined distance in time or space from the pickup location, the computing devices 110 may begin to look for a place to pull over. This may include a parking spot, shoulder area, or another location to stop the vehicle to allow the passenger to enter the vehicle. Once the passenger enters the vehicle 100, the vehicle may continue, for example the computing devices 110 may control the vehicle in the autonomous driving mode in order to transport the passenger to the passenger's destination location as well as to any intermediate destination locations.

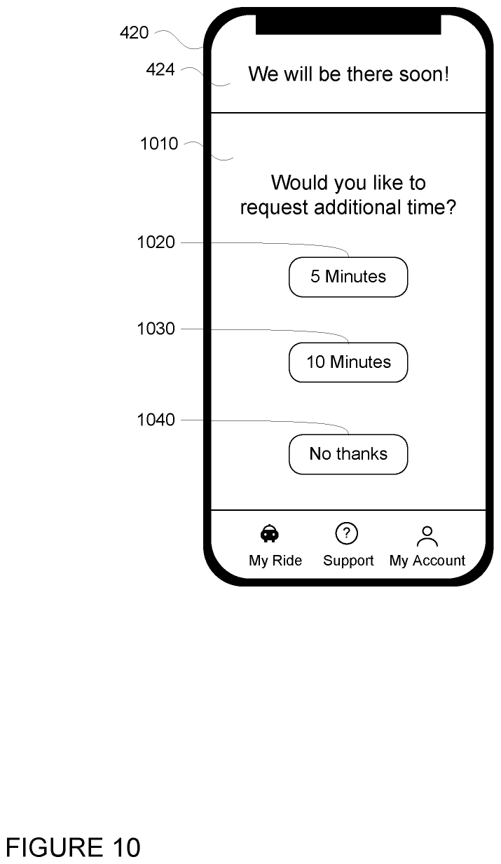

In some instances, when the first triggering condition has not met but the second triggering condition has, the passenger may be prompted at their client computing device to confirm that the passenger is ready for pickup. This prompt may come with a notification identifying when the vehicle expects to arrive at the pickup location and may even allow the passenger an option to request additional time, such as 5 or 10 additional minutes or more or less. This additional time may be added to the estimated time of arrival and used to adjust the vehicle's route and trajectories (including speed) as described above. FIG. 10 is an example of client computing device 410 with a notification 1010 which allows the user 422 to select options 1020, 1030 to request additional time or option 1040 to decline additional time. By selecting options 1020 or 1030, the client computing device 420 may send a notification to the server computing devices 410 and/or directly to the computing devices 110 requesting additional time, here 5 or 10 minutes, respectively. In response, when received by the server computing devices 410, the server computing devices may send an instruction to the computing devices 110 to adjust the estimated time of arrival by an amount the requested additional time. Alternatively in response to receiving the notification or in response to receiving the instruction, the computing devices 110 may adjust the estimated time of arrival by an amount of the requested additional time. This adjusted estimated time of arrival may then be used by the computing devices 110 in order to maneuver the vehicle to reach the pickup location as close to the adjusted estimated time of arrival as possible as described above.

The features described herein may allow for better timing of pickups for autonomous vehicles and thereby improve the precision of each passenger pickup. By enabling vehicles to reach pickup locations as close as possible to when a passenger arrives, this may also reduce the likelihood of a vehicle needing to find a parking spot, minimize the time spent pulled over and waiting, and also reduce the likelihood of a vehicle needing to double park or drive around the block.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method of timing pickups of passengers for autonomous vehicles, the method comprising:
while an autonomous vehicle is maneuvering itself to a pickup location for picking up a passenger, identifying, by one or more processors of the vehicle, an estimated time of arrival for the passenger to reach the pickup location;
using, by the one or more processors, the estimated time of arrival to plan a route to the pickup location and determine trajectories in order to follow the route; and
maneuvering, by the one or more processors, the vehicle to the pickup location using the route and the determined trajectories.

2. The method of claim 1, further comprising, determining the estimated time of arrival based on a location of a client computing device and a distance between the location of the client computing device and the pickup location.

3. The method of claim 2, wherein the estimated time of arrival is determined further based on an expected walking speed.

4. The method of claim 2, wherein determining the estimated time of arrival is in response to a triggering condition being met.

5. The method of claim 4, wherein the triggering condition is a predetermined amount of time before the vehicle is expected to arrive at the pickup location.

6. The method of claim 4, wherein the triggering condition is the location of the client computing device indicates that the passenger is moving towards the pickup location.

7. The method of claim 2, wherein determining the estimated time of arrival is further based on whether the location of the client computing device indicates that the passenger is within a building.

8. The method of claim 7, wherein determining the estimated time of arrival is further based on a number of stories the building has.

9. The method of claim 7, wherein determining the estimated time of arrival is further based on a classification of the building.

10. The method of claim 9, wherein the classification is an airport.

11. The method of claim 9, wherein the classification is a shopping center.

12. The method of claim 9, wherein the classification is an apartment building.

13. The method of claim 9, wherein the classification is a house.

14. The method of claim 2, wherein determining the estimated time of arrival is further based on current weather conditions at the pickup location.

15. The method of claim 2, wherein determining the estimated time of arrival is further based on current time of day at the pickup location.

16. The method of claim 2, wherein determining the estimated time of arrival is further based on congestion conditions at the pickup location.

17. The method of claim 16, wherein the congestion conditions include pedestrian traffic.

18. The method of claim 16, wherein the congestion conditions include vehicular traffic.

19. (canceled)

20. The method of claim 1, wherein when a predetermined amount of time before the vehicle is expected to arrive at the pickup location has been reached and a received location of the client computing device indicates that the passenger is not moving towards the pickup location, sending a notification to the client computing device asking if the passenger would like to request more time to reach the pickup location.
